(19) United States
(12) Patent Application Publication
(10) Pub. No.: US 2006/0238515 A1
(43) Pub. Date: Oct. 26, 2006

(54) Input device

(75) Inventor: Kazuhito Ohshita, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/409,783

(22) Filed: Apr. 24, 2006

(30) Foreign Application Priority Data
Apr. 26, 2005 (JP) 2005-128473

(51) Int. Cl. G09G 5/00

(52) U.S. Cl. 345/173

(57) ABSTRACT

An input device that allows a user to move a pointer with a few operations to resize a window displayed on a screen of a personal computer, is provided. The input device includes an operating surface with a predetermined specific region for detecting contact from an operating object, such as a finger. When a contact of an operating object is detected while displaying a resizable window on the display screen of a display unit, a data processor outputs a processing signal for allowing a pointer displayed on the display screen to jump to a resizing region of the window.

### BACKGROUND OF THE INVENTION

1. Field of the Invention

The present invention relates to input devices for computers. More specifically, the present invention relates to an input device that allows a user to easily and quickly move a pointer with a few operations to resize a window displayed on a screen of a personal computer.

2. Description of the Related Art

In personal computers, in order to increase or decrease the size of a window displayed on the screen to resize the window, a pointer is moved to any of resizing regions provided at the four corners of the window or the upper, lower, left, and right edges of the window, and the pointer is dragged to the inside or outside of the window.

Japanese Unexamined Patent Application Publication No. 6-103013 discloses a technical concept of resizing a window.

In general, a pointer for resizing a window displayed on a screen of a personal computer is moved by operating a mouse serving as an input device connected to the personal computer for use.

Recently, however, pad-type input devices incorporated in personal computers, rather than mice connected to personal computers, have been increasingly used as input devices for personal computers.

In a pad-type input device, a pointer is moved by sliding a finger over an operation surface defined on a surface of the device.

Since the resizing regions of the window are narrow, it is difficult to accurately move the pointer to the resizing regions of the window by sliding the finger over the operation surface of the pad-type input device. Thus, the usability is so low that it is difficult to readily move the pointer.

Pad-type input devices are typically provided in relatively narrow spaces of personal computers, and there are limitations in increasing the size of operation surfaces.

A user who uses a pad-type input device to move a pointer needs to slide the finger within a small operation surface, and it is difficult to move the pointer to the resizing regions of the window.

### SUMMARY OF THE INVENTION

Accordingly, it is an object of the present invention to provide an input device that allows a user to easily and quickly move a pointer to resize a window displayed on a display screen of a personal computer.

According to an aspect of the present invention, an input device includes an operating surface, a detector that detects a contact of an operating object with the operation surface and that determines coordinates of a position contacted by the operating object on the operation surface, and a data processor that outputs a processing signal based on a detection signal obtained from the detector. When a specific operation on a predetermined specific region on the operation surface is detected while displaying a resizable window on a display screen, the data processor outputs a processing signal for allowing a pointer displayed on the display screen to jump to a resizing region of the window.

In the input device according to the aspect of the present invention, when a contact of an operating object, such as a finger, with a predetermined specific region on the operating surface is detected, a processing signal for allowing the pointer displayed on the display screen to jump to the resizing region of the window is output.

This allows an easy operation of moving the pointer to the resizing region of the window to resize the display area of the window. It is therefore possible to easily resize the display area of the window.

Further, a jump process provides instant movement of the pointer, and allows the pointer to be moved quickly as compared to the typical operation of sliding the finger over the operating surface of the input device. It is therefore possible to quickly resize the window.

The data processor may output a processing signal for catching the resizing region as well as allowing the pointer to jump to the resizing region when the specific operation on the predetermined specific region on the operation surface is detected.

With this structure, the pointer can instantly jump to the resizing region of the window, and a drag operation can automatically be performed in this stage. It is therefore possible to easily and quickly resize the window without performing a drag-mode switching operation to switch to the drag mode, such as the operation of tapping the operating surface of the input device successively two times and then sliding the finger after the second tap without releasing the finger, or the operation of continuously pressing the left button.

The data processor may determine whether or not the specific operation after the pointer jumps to the resizing region is detected, and may output the processing signal for catching the resizing region after the predetermined operation is detected.

This also allows easy movement of the pointer without sliding the finger over the operating surface. It is therefore possible to easily resize the display area of the window.

The data processor may output the processing signal for catching the resizing region when an operation of the operation surface by the operating object is detected. The operation of the operation surface may be a tap.

A button input device may be provided adjacent to the operation surface, and the data processor may output the processing signal for catching the resizing region when an operation of the button input device is detected.

Further, when movement of the operating object over the operation surface is detected after the processing signal for catching the resizing region is output, the data processor may output a processing signal for changing the size of the window displayed on the display screen in accordance with the movement of the operating object.

Further, the data processor may output a processing signal for canceling a catch process of the resizing region when a specific operation is performed. For example, the data processor may output a processing signal for canceling a catch process of the resizing region when a release of the operating object from the operation surface is detected. Alternatively, the data processor may output a processing signal for canceling a catch process of the resizing region when a predetermined time elapses after the processing signal for catching the resizing region is output.

Thus, the catch process is canceled, and the normal operation according to the setting of the data processor is performed.

Further, a setting unit that sets the specific region on the operation surface may be provided.

The specific region may be set so that the setting position on the operation surface and the size of the region can arbitrarily be set.

In an input device according to the present invention, therefore, a processing signal for allowing a pointer displayed on a display screen to jump to a resizing region of a window is output when a contact of an operating object, such as a finger, with a predetermined specific region on an operating surface is detected.

This allows an easy operation of moving the pointer to the resizing region of the window to resize the display area of the window. It is therefore possible to easily resize the display area of the window.

Further, a jump process provides instant movement of the pointer, and allows the pointer to be moved quickly as compared to the typical operation of sliding the finger over the operating surface of the input device. It is therefore possible to quickly resize the window.

### BRIEF DESCRIPTION OF THE DRAWINGS

FIG. 1 is a perspective view of a personal computer incorporating an input device according to the present invention;

FIG. 2 is a partial enlarged plan view of the input device incorporated in the personal computer shown in FIG. 1;

FIG. 3 is a circuit block diagram of the input device shown in FIG. 2;

FIG. 4 is a diagram illustrating an exemplary window displayed on the display screen of the personal computer shown in FIG. 1;

FIG. 5 is a flowchart showing an operation process of a pointer when the input device shown in FIG. 2 is used; and

FIG. 6 is a flowchart showing a portion of the operation process shown in FIG. 5 in more detail.

### DESCRIPTION OF THE PREFERRED EMBODIMENTS

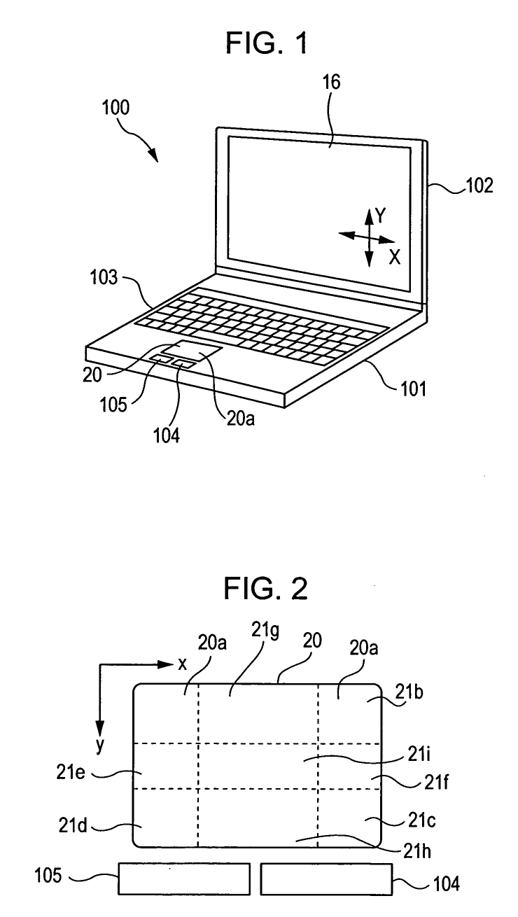

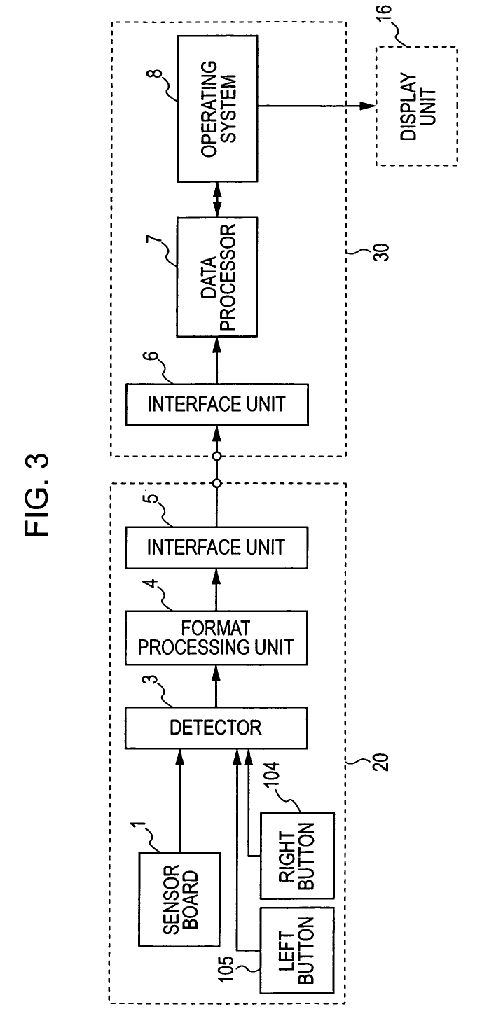

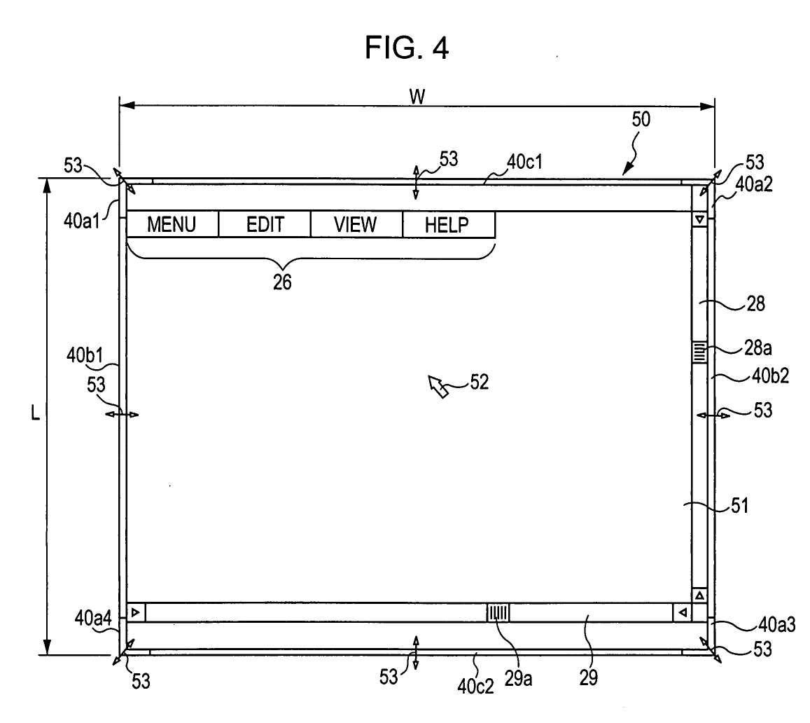

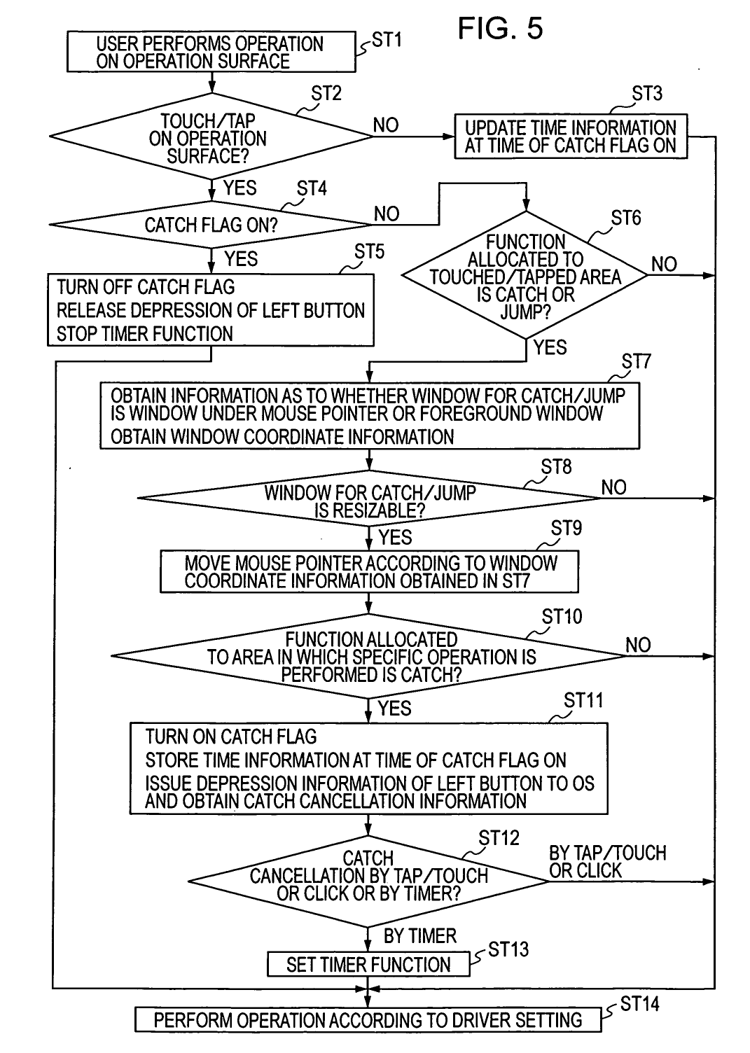

FIG. 1 is a perspective view of a notebook personal computer incorporating an input device according to the present invention. FIG. 2 is a partial enlarged plan view of the input device incorporated in the personal computer shown in FIG. 1. FIG. 3 is a circuit block diagram of the input device shown in FIG. 2. FIG. 4 is a diagram illustrating an exemplary window displayed on the display screen of the personal computer shown in FIG. 1. FIG. 5 is a flowchart showing an operation process of a pointer when the input device shown in FIG. 2 is used.

Referring to FIG. 1, a notebook personal computer 100 has a main body 101 and a display housing 102. The main body 101 includes a keyboard device 103 serving as an operating device. As shown in FIGS. 1 and 2, the main body 101 further includes a pad-type input device 20 as an exemplary implementation of the input device according to the present invention, and a right button 104 and a left button 105 located adjacent to the pad-type input device 20.

The keyboard device 103 includes a plurality of keys and a keyboard switch for detecting the operation of the keys. An operation signal of the keyboard switch is transferred to a data processor 7 in a main body controller 30 shown in FIG. 3 via a processing circuit (not shown).

The pad-type input device 20 has an operation surface 20a, and a sensor board 1 shown in FIG. 3 is provided below the operation surface 20a. In the embodiment illustrated in FIGS. 1 and 2, the plan-view shape of the operation surface 20a is rectangular although the plan-view shape of the operation surface 20a is not limited thereto.

The sensor board 1 includes x-electrodes 1x arranged in parallel with predetermined pitches in the vertical direction (y-direction in FIG. 2), and y-electrodes 1y arranged in parallel with predetermined pitches in the horizontal direction (x-direction in FIG. 2), and the x-electrodes 1x and the y-electrodes 1y face each other with a dielectric member having a predetermined electrostatic capacitance therebetween. The x-electrodes 1x are sequentially supplied with charge from a control drive unit (not shown) via a vertical scanning unit (not shown), and the y-electrodes 1y are sequentially supplied with charge from a control drive unit (not shown) via a horizontal scanning unit (not shown).

The operation surface 20a is provided with a protective layer covering the sensor board 1. When an operating object composed of a conductive element, such as a human finger, is brought into contact with any part of the sensor board 1, the electrostatic capacitance between the x-electrodes 1x and the y-electrodes 1y changes at the contact position. An operation signal based on the change in electrostatic capacitance is transferred to a detector 3 to determine whether the contact of the finger with the sensor board 1 is a tap or touch, or a slide. The detector 3 further detects the tap or touch position and the slide position by using X-Y coordinate information.

The “tap” is an operation of an operating object, such as a finger, when the operating object contacts a certain position on the operation surface 20a and then is instantly released within a predetermined period of time, and the detector 3 detects the contact position and the change in electrostatic capacitance. The “touch” is an operation of an operating object, such as a finger, when the operating object contacts a certain position on the operation surface 20a and then is released within a predetermined period of time, wherein the period of time during which the operating object, such as the finger, is brought into contact is longer than that of the tap, and the detector 3 detects the contact position and the change in electrostatic capacitance. The “slide” is an operation of a finger contacting a certain position on the operation surface 20a and then moving over the operation surface 20a in contact with the operation surface 20a, and the detector 3 detects the change in the coordinates of the contact position.

The tap or touch or the slide may be detected by the main body controller 30 described below.

As shown in FIGS. 1 and 2, the right button 104 and the left button 105 are located side-by-side with respect to the operation surface 20a of the pad-type input device 20, and are associated with right and left switches, respectively. An operation signal of the right switch and an operation signal of the left switch are also detected by the detector 3 shown in FIG. 3. The right button 104 and the left button 105 form a button input device according to the present invention. Alternatively, a button input device according to the present invention may be formed of the right button 104, the left button 105, and other buttons.

The operation signal detected by the detector 3 is converted into a predetermined format by a format processing unit 4, and the resulting signal is transferred to the data processor 7 of the main body controller 30 in the main body 101 of the notebook personal computer 100 via interface units 5 and 6. In the data processor 7, a software program, called driver software, generates a control signal according to the operation signal from the detector 3. The control signal is supplied to an operating system 8 to control various information displayed on a display screen of a display unit 16 according to the operation signal.

The operating system 8 is capable of controlling the display of an image on the display unit 16 according to the program operation of application software (not shown).

Examples of processing signals generated by the data processor 7 include a processing signal for moving a pointer 52 described below, and a processing signal for a jump process or catch process described below. The details of the processing will be described below.

FIG. 4 illustrates an exemplary window 50 displayed on the display screen of the display unit 16. The window 50 illustrated in FIG. 4 is a document creation window, and includes a plurality of menus 26 in the upper left portion. A scroll bar 28 is displayed in the right portion of the window 50, and a slider 28a that is movable up and down in a one-dimensional line is displayed in the scroll bar 28. A scroll bar 29 extending in the horizontal direction is displayed in the lower edge of the display screen. When a slider 29a of the scroll bar 29 is moved right and left, the character string is moved to the right and left in a one-dimensional line.

Further referring to FIG. 4, display information (not shown), e.g., character strings, is displayed on a display region 51 other than the menus 26 and the scroll bar 28. The pointer 52 is displayed in the display region 51, and is movable in any direction on the display unit 16 by sliding an operating object, such as a finger, over the operation surface 20a of the pad-type input device 20. As shown in FIG. 4, the pointer 52 located in the display region 51 normally takes the shape of an arrow.

As shown in FIG. 4, the window 50 includes resizing regions 40a1, 40a2, 40a3, 40a4, 40b1, 40b2, 40c1, and 40c2 that are continuously provided so as to surround the circumferential edge of the window 50.

The resizing regions 40a1, 40a2, 40a3, and 40a4 are defined at the four corners of the window 50. As shown in FIG. 4, when the pointer 52 located in the display region 51 is moved to the resizing region 40a1, 40a2, 40a3, or 40a4, the arrow-shaped pointer 52 is changed to a resizing pointer 53, which is normally in the shape of a double arrow. When the double-arrow resizing pointer 53 is displayed, the pointer 53 is dragged to the outside of the window 50, thereby increasing a width W of the window 50 and a longitudinal length L of the window 50 to increase the display size of the window 50. When the double-arrow resizing pointer 53 is displayed, the pointer 53 is dragged to the inside of the window 50, thereby decreasing the width W of the window 50 and the longitudinal length L of the window 50 to decrease the display size of the window 50.

The resizing regions 40b1 and 40b2 are defined at the left and right edges of the window 50, respectively. As shown in FIG. 4, when the pointer 52 located in the display region 51 is moved to the resizing region 40b1 or 40b2, the arrow-shaped pointer 52 is changed to the resizing pointer 53, which is normally in the shape of a double arrow. When the double-arrow resizing pointer 53 is displayed, the pointer 53 is dragged to the outside of the window 50, thereby increasing the width W of the window 50 while the longitudinal length L of the window 50 does not change to increase the display size of the window 50. When the double-arrow resizing pointer 53 is displayed, the pointer 53 is dragged to the inside of the window 50, thereby decreasing the width W of the window 50 while the longitudinal length L of the window 50 does not change to decrease the display size of the window 50.

The resizing regions 40c1 and 40c2 are defined at the upper and lower edges of the window 50, respectively. As shown in FIG. 4, when the pointer 52 located in the display region 51 is moved to the resizing region 40c1 or 40c2, the arrow-shaped pointer 52 is changed to the resizing pointer 53, which is normally in the shape of a double arrow. When the double-arrow resizing pointer 53 is displayed, the pointer 53 is dragged to the outside of the window 50, thereby increasing the longitudinal length L of the window 50 while the width W of the window 50 does not change to increase the display size of the window 50. When the double-arrow resizing pointer 53 is displayed, the pointer 53 is dragged to the inside of the window 50, thereby decreasing the longitudinal length L of the window 50 while the width W of the window 50 does not change to decrease the display size of the window 50.

In the pad-type input device 20, when a specific operation, such as the operation of bringing an operating object, such as a finger, into contact by a tap or touch, is performed within a region (a specific region of the present invention) in which the operation surface 20a is set to a “jump mode”, the pointer 52 instantly jumps to the resizing region 40a1, 40a2, 40a3, 40a4, 40b1, 40b2, 40c1, or 40c2, and the resizing pointer 53 is displayed in the window 50. The mode in which the pointer 52 is set to instantly jump to a resizing region is hereinafter referred to as a “jump mode”, and the process for allowing the pointer 52 to instantly jump to the resizing region is hereinafter referred to as a “jump process”. The jump process is performed according to the output of the processing signal generated by the data processor 7 for allowing the pointer 52 to jump to the coordinate position.

When a predetermined operation, e.g., a normal drag-mode switching operation, such as the operation of tapping the operation surface 20a successively two times and sliding the finger after the second tap without releasing the finger, or the operation of continuously pressing the left button 105, is performed while displaying the resizing pointer 53 in the window 50, the data processor 7 detects the predetermined operation. A drag operation is performed by sliding the operating object, such as the finger, over the operation surface 20a after the predetermined operation, such as the operation of double tapping the operation surface 20a or the operation of continuously pressing the left button 105, thereby resizing the display area of the window 50 in accordance with the movement of the operating object, such as the finger, in the manner described above.

Further, in the pad-type input device 20, when a specific operation, such as the operation of bringing an operating object, such as a finger, into contact by a tap or touch, is performed within a region (a specific region of the present invention) in which the operation surface 20a is set to a “catch mode”, the pointer 52 instantly jumps to the resizing region 40a1, 40a2, 40a3, 40a4, 40b1, 40b2, 40c1, or 40c2, and the resizing pointer 53 is displayed in the window 50. In this stage, a drag mode is automatically set to catch the resizing region 40a1, 40a2, 40a3, 40a4, 40b1, 40b2, 40c1, or 40c2.

Thus, by sliding an operating object, such as a finger, in contact with the operation surface 20a after moving the pointer 52 to the resizing region 40a1, 40a2, 40a3, 40a4, 40b1, 40b2, 40c1, or 40c2 by a tap or touch, a drag operation is performed to resize the window 50 in accordance with the movement of the operating object, such as the finger. The resizing operation is performed according to a processing signal for resizing the window 50 in accordance with the movement of the operating object, such as the finger. This processing signal is output from the data processor 7. It is therefore possible to easily and quickly resize the window 50 without performing a drag-mode switching operation to switch to the drag mode, such as the operation of double tapping the operation surface 20a or the operation of continuously pressing the left button 105. The mode in which the pointer 52 is set to instantly jump to a resizing region and in which the drag mode is set is hereinafter referred to as a “catch mode”, and the process for allowing the pointer 52 to instantly jump to the resizing region and setting the drag mode is hereinafter referred to as a “catch process”. The catch process is performed according to the output of the processing signal generated by the data processor 7 for turning on a catch flag.

The catch process is canceled by the data processor 7 outputting a processing signal for canceling the catch process of the resizing region when the specific operation or the like is performed. For example, the data processor 7 may automatically cancel the catch process according to a processing signal for turning off the catch flag when a predetermined period of time elapses after the catch flag is turned on. Alternatively, the data processor 7 may cancel the catch process according to a processing signal for turning off the catch flag when an operation, such as a tap or touch on the operation surface 20a or a click of the left button 105, is detected. Alternatively, the data processor 7 may cancel the catch process according to a processing signal for turning off the catch flag when, in the catch mode, a release of an operating object, such as a finger, from the operation surface 20a is detected after sliding the operating object, such as the finger, over the operation surface 20 to resize the display area of the window 50a.

The setting of a predetermined region of the operation surface 20a to the “jump mode” or “catch mode”, that is, the setting for applying the “jump process” or the “catch process” to the “specific region” of the present invention, can be performed by a setting unit via the window 50.

The processing operation of the pad-type input device 20 will be described with reference to the flowchart shown in FIG. 5. The process shown in the flowchart of FIG. 5 is performed by the data processor 7.

First, the user performs an operation on the operation surface 20a of the pad-type input device 20 (step ST1).

Then, it is determined whether or not the operation on the operation surface 20a in step ST1 is a tap or touch on the operation surface 20a (step ST2). If it is determined that no tap or touch is performed on the operation surface 20a (“NO” in step ST2), time information at the time of turning on a catch flag for performing the catch process is updated (step ST3), and a normal operation according to the setting of the driver software of the data processor 7 is performed (step ST14).

If it is determined that a tap or touch is performed on the operation surface 20a (“YES” in step ST2), it is determined whether or not the catch flag is set to ON (step ST4). If the catch flag is set to ON (“YES” in step ST4), the catch flag is turned off, and the depression of the left button 105 is released to stop a timer function (step ST5). The timer function is a programming language function for use in a process to be automatically executed at the lapse of a predetermined time, and, herein, is a programming language function for use in a process for automatically turning off the catch flag at the lapse of a predetermined time.

If the catch flag is not set to ON (“NO” is step ST4), it is determined whether the function allocated to the region of the operation surface 20a in which the tap or touch on the operation surface 20a has been performed is the jump or catch process (step ST6).

FIG. 2 illustrates an embodiment of the present invention in which the operation surface 20a is divided into a plurality of detection regions. In the embodiment illustrated in FIG. 2, the operation surface 20a is divided into nine detection regions, i.e., detection regions 21a, 21b, 21c, 21d, 21e, 21f, 21g, 21h, and 21i. In the pad-type input device 20, the function for performing the jump process or the catch process may be allocated to some or all of the nine detection regions 21a, 21b, 21c, 21d, 21e, 21f, 21g, 21h, and 21i of the operation surface 20a. For example, in the embodiment illustrated in FIG. 2, the function for the jump process or the catch process is allocated to the detection regions other than the detection region 21i, i.e., the detection regions 21a, 21b, 21c, 21d, 21e, 21f, 21g, and 21h. The detection regions 21a, 21b, 21c, 21d, 21e, 21f, 21g, and 21h to which the function for the jump process or the catch process is allocated form the specific region of the present invention. Alternatively, for example, only the detection region 21b of the operation surface 20a may be allocated the function for the jump process or the catch process, and may form the specific region.

Which of the detection regions 21a, 21b, 21c, 21d, 21e, 21f, 21g, 21h, and 21i the function for the jump process or the catch process is allocated to (that is, which detection region forms the specific region), that is, the setting position of the specific region, can be set in the setting unit of the data processor 7 via a setting change window displayed on the display screen of the display unit 16.

The size (proportion) of the region (specific region) in the detection regions 21a, 21b, 21c, 21d, 21e, 21f, 21g, 21h, and 21i to which the function for the jump process or the catch process is allocated with respect to the operation surface 20a can also be set in the setting unit of the data processor 7 via the setting change window displayed on the display screen of the display unit 16. For example, when the function for the jump process or the catch process is allocated to only the detection region 21b shown in FIG. 2 to form the specific region, the size of the detection region 21b can be set in the setting unit of the data processor 7 via the setting change window displayed on the display screen of the display unit 16.

If it is determined that the function allocated to the tapped or touched detection region 21a, 21b, 21c, 21d, 21e, 21f, 21g, 21h, or 21i in the operation surface 20a is not the function for the jump process or the catch process (if it is determined that the tapped or touched region is not the specific region) (“NO” in step ST6), the normal operation according to the setting of the driver software of the data processor 7 is performed (step ST14).

If it is determined that the function allocated to the tapped or touched region in the operation surface 20a is the function for the jump process or the catch process (if it is determined that the tapped or touched region is the specific region), the jump mode or the catch mode is set.

In the pad-type input device 20 shown in FIG. 2, since the detection regions other than the detection region 21i in the detection regions 21a, 21b, 21c, 21d, 21e, 21f, 21g, 21h, and 21i, i.e., the detection regions 21a, 21b, 21c, 21d, 21e, 21f, 21g, and 21h, form the specific region, the jump mode or the catch mode is set when the detection region 21a, 21b, 21c, 21d, 21e, 21f, 21g, or 21h is tapped or touched.

If the function allocated to the tapped or touched region in the operation surface 20a is the function for the jump process or the catch process, the jump mode or the catch mode is set (“YES” in step ST6), setting information as to whether the window in which the jump or touch process of the pointer 52 is performed is the window under the pointer 52, that is, the window in which the pointer 52 is being displayed, or the foreground window is read (step ST7). The setting information can be set in the setting unit of the data processor 7 via the setting change window displayed on the display screen of the display unit 16.

The coordinate information of the position to which the pointer 52 is to be moved is also read from the setting information of the data processor 7 (step ST7). The position to which the pointer 52 is to be moved specifies which of the resizing regions 40a1, 40a2, 40a3, 40a4, 40b1, 40b2, 40c1, and 40c2 of the window 50 to move the pointer 52 to. In the jump mode or the catch mode, the jump destination of the pointer 52 is specified according to the coordinate information.

For example, information specifying which of the resizing regions 40a1, 40a2, 40a3, and 40a4 at the four corners of the window 50, the resizing region 40b1 or 40b2 at the right or left edge of the window 50, or the resizing region 40c1 or 40c2 at the upper or lower edge of the window 50 to move the pointer 52 to in the jump mode or the catch mode is read.

The coordinate information may also include information as to which position of the resizing region 40a1, 40a2, 40a3, 40a4, 40b1, 40b2, 40c1, or 40c2, such as an end or the center of the resizing region 40a1, 40a2, 40a3, 40a4, 40b1, 40b2, 40c1, or 40c2, to move the pointer 52 to.

The coordinate information of the position to which the pointer 52 is to be moved is set so that the position to which the pointer 52 is to be moved can be changed according to the detection information as to which region of the detection regions 21a, 21b, 21c, 21d, 21e, 21f, 21g, 21h, and 21i defined in the operation surface 20a of the pad-type input device 20 has been tapped or touched. For example, in the pad-type input device 20 of the embodiment illustrated in FIG. 2, the pointer 52 is set to jump to the resizing region 40a1 when the detection region 21a is tapped or touched; the pointer 52 is set to jump to the resizing region 40a2 when the detection region 21b is tapped or touched; the pointer 52 is set to jump to the resizing region 40a3 when the detection region 21c is tapped or touched; and the pointer 52 is set to jump to the resizing region 40a4 when the detection region 21d is tapped or touched.

Further, in the pad-type input device 20 of the embodiment illustrated in FIG. 2, the pointer 52 is set to jump to the resizing region 40b1 when the detection region 21e is tapped or touched, and the pointer 52 is set to jump to the resizing region 40b2 when the detection region 21f is tapped or touched.

Further, in the pad-type input device 20 of the embodiment illustrated in FIG. 2, the pointer 52 is set to jump to the resizing region 40c1 when the detection region 21g is tapped or touched, and the pointer 52 is set to jump to the resizing region 40c2 when the detection region 21h is tapped or touched.

In this manner, the coordinate information is set for each of the plurality of detection regions 21a, 21b, 21c, 21d, 21e, 21f, 21g, and 21h, thus allowing the user to select a certain operation position on the operation surface 20a to select the position to which the pointer jumps.

The setting information for the coordinate positions can be set in the setting unit of the data processor 7 via the setting change window displayed on the display screen of the display unit 16.

Then, it is determined whether or not the window 50 in which the jump process or the catch process is performed is resizable (step ST8). If the window 50 is not resizable, it is meaningless to move the pointer 52 to the resizing region 40a1, 40a2, 40a3, 40a4, 40b1, 40b2, 40c1, or 40c2 of such a non-resizable window 50, and such a meaningless jump of the pointer 52 to any of the four corners or an edge of the non-resizable window 50 is eliminated.

If the window 50 in which the jump process or the catch process is performed is not resizable (“NO” in step ST8), the normal operation according to the setting of the driver software of the data processor 7 is performed (step ST14).

If the window 50 in which the jump process or the catch process is performed is resizable (“YES” in step ST8), the pointer 52 jumps to the coordinate position according to the coordinate information of the position to which the pointer 52 is to be moved obtained in step ST7 (step ST9). This jump is performed by outputting the processing signal generated by the data processor 7 for allowing the pointer 52 to jump to the coordinate position to the operating system 8 and by the operating system 8 allowing the pointer 52 displayed on the display unit 16 to jump according to the processing signal. When the pointer 52 is moved to the resizing region 40a1, 40a2, 40a3, 40a4, 40b1, 40b2, 40c1, or 40c2 according to this operation, as discussed above, the pointer 52 is changed to the resizing pointer 53.

Then, it is determined whether the function allocated to the tapped or touched region in the operation surface 20a is the jump process or the catch process (step ST10).

If the function allocated to the region is the jump process, since the jump process to be achieved by the pad-type input device 20 of the present invention has been finished in step ST6, the normal operation according to the setting of the driver software of the data processor 7 is performed (step ST14).

In this case, the user is able to resize the window 50 by performing a predetermined operation, such as the drag operation of moving the resizing pointer 53 located at the resizing region 40a1, 40a2, 40a3, 40a4, 40b1, 40b2, 40c1, or 40c2 while continuously pressing the left button 105, after the jump process.

In the drag operation, as described above, for example, the pointer 53 is dragged to the outside of the window 50, thereby increasing the display size of the window 50 in accordance with the movement of the operating object, such as the finger, and the pointer 53 is dragged to the inside of the window 50, thereby decreasing the display size of the window 50 in accordance with the movement of the operating object, such as the finger.

However, the operation of resizing the window 50 is not limited to the drag operation, and other operations may be performed according to the setting of the data processor 7 to resize the window 50.

If the function allocated to the region is the catch process (“YES” in step ST10), the catch flag for performing the catch process is turned on, and information for a double tap of the operation surface 20a or depression of the left button 105 is issued to the operating system 8 (step ST11).

At this time, catch mode cancellation information as to whether the catch mode is canceled automatically by using a timer or is canceled by the user tapping or touching the operation surface 20a or clicking the left button 105 is obtained. Time information at the time of turning on the catch flag is also stored (step ST11).

In step ST12, it is determined whether the catch mode cancellation obtained in step ST11 indicates automatic cancellation by using the timer or cancellation by tapping or touching the operation surface 20a or clicking the left button 105.

If it is determined that the cancellation information indicates automatic cancellation by using the timer, the timer function is set and the operation according to the timer function is performed (step ST13). Then, the normal operation according to the setting of the driver software of the data processor 7 is performed (step ST14).

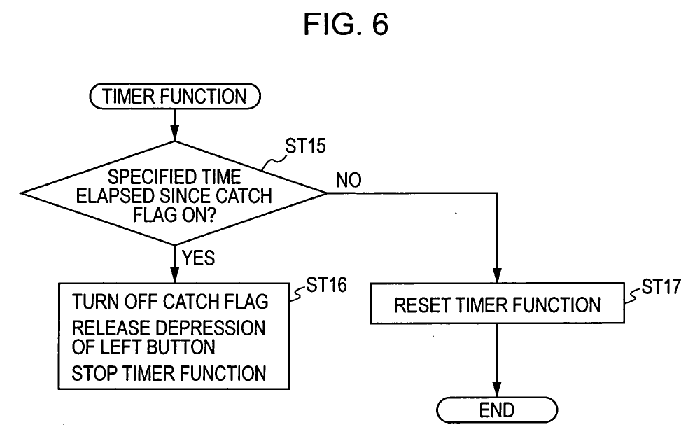

The operation according to the timer function (step ST13) includes, for example, as shown in FIG. 6, an operation of automatically canceling the catch process at the lapse of a time specified by the timer, and an operation of not automatically canceling the catch process when the specified time is not elapsed. The specified time is determined according to the time information at the time of turning on the catch flag in steps ST11 and ST3.

Referring to FIG. 6, it is determined whether or not the time specified by the timer has elapsed (step ST15). If the time specified by the timer has elapsed (“YES” in step ST15), the catch flag turned on in step ST11 is turned off, and the information for the drag mode switching operation, such as the operation of double tapping the operation surface 20a or the operation of continuously pressing the left button 105 is canceled to cancel the catch process (step ST16). The processing signal for turning off the catch flag and canceling the information for the drag mode switching operation is output from the data processor 7 to the operating system 8.

If the time specified by the timer has not elapsed (“NO” in step ST15 in FIG. 6), the timer function is reset according to the time information obtained in step ST3 and the time at which the timer function was executed (step ST17).

Alternatively, the operation according to the timer function (step ST13) may include the following operation.

Even if automatic cancellation by using the timer is selected, first, it is determined whether or not an event of tapping or touching the operation surface 20a or clicking the left button 105 to cancel the catch mode is detected.

If it is determined that the event of tapping or touching the operation surface 20a or clicking the left button 105 is detected, the catch flag turned on in step ST11 is turned off, and the information for the drag mode switching operation, such as the operation of double tapping the operation surface 20a or the operation of continuously pressing the left button 105, is canceled to cancel the catch process.

Alternatively, the data processor 7 may output a processing signal for turning off the catch flag to the operating system 8 when it is determined that a release of an operating object, such as a finger, from the operation surface 20a is detected in the catch mode after sliding the operating object, such as the finger, over the operation surface 20a to resize the display area of the window 50, thereby canceling the catch process.

Therefore, even if automatic cancellation by using the timer is selected, the operation according to the timer function (step ST13) includes the operation of determining whether or not an event of tapping or touching the operation surface 20a or clicking the left button 105 to cancel the catch mode is detected, thus preventing the catch process from being not canceled due to a malfunction of the timer when the cancellation of the catch process by using the timer is selected. This ensures that the catch process is canceled.

If it is determined in step ST12 that the cancellation information is an event of tapping or touching the operation surface 20a or clicking the left button 105, the normal operation according to the setting of the driver software of the data processor 7 is performed (step ST14).

The normal operation according to the setting of the driver software of the data processor 7 (step ST14) includes, for example, the following operation.

First, it is determined whether or not an event of tapping or touching the operation surface 20a or clicking the left button 105 is detected.

If the event of tapping or touching the operation surface 20a or clicking the left button 105 is detected, the catch flag turned on in step ST11 is turned off, and the information for the drag mode switching operation, such as the operation of double tapping the operation surface 20a or the operation of continuously pressing the left button 105, is canceled to cancel the catch mode.

If the event of tapping or touching the operation surface 20a or clicking the left button 105 is not detected, it is determined again whether or not the event of tapping or touching the operation surface 20a or clicking the left button 105 is detected until the end of the catch mode. The catch mode ends when the catch flag turned on in step ST11 is turned off and the information for the drag mode switching operation, such as the operation of double tapping the operation surface 20a or the operation of continuously pressing the left button 105, is canceled.

In the pad-type input device 20 as an exemplary implementation of the input device according to the present invention, if a tap or touch is performed on the operation surface 20a when the jump mode or the catch mode is set (step ST6) by tapping or touching (step ST2) the operation surface 20a, the pointer 52 instantly jumps to the resizing region 40a1, 40a2, 40a3, 40a4, 40b1, 40b2, 40c1, or 40c2, and the resizing pointer 53 is displayed on the window 50 (step ST9).

Accordingly, it is only required to tap or touch the operation surface 20a of the pad-type input device 20 to perform the operation for moving the pointer 52 to the resizing region 40a1, 40a2, 40a3, 40a4, 40b1, 40b2, 40c1, or 40c2 of the window 50 to resize the display area of the window 50. Therefore, only a tap or touch allows easy movement of the pointer 52 to readily resize the display area of the window 50 without performing the typical operation of sliding the finger over the narrow operation surface 20a of the pad-type input device 20 to move the pointer 52 to the resizing region 40a1, 40a2, 40a3, 40a4, 40b1, 40b2, 40c1, or 40c2.

Particularly, the pad-type input device 20 is generally provided in a relatively narrow space of the personal computer 100, and there are limitations in increasing the size of the operation surface 20a. According to the pad-type input device 20 of the present invention, a tap or touch (step ST2) of the operation surface 20a is only required to move the pointer 52 to the resizing region 40a1, 40a2, 40a3, 40a4, 40b1, 40b2, 40c1, or 40c2 of the window 50 (step ST9). This ensures easy movement of the pointer 52 even over the narrow operation surface 20a. It is therefore possible to easily and accurately resize the display area of the window 50.

Furthermore, since the pointer 52 is instantly moved by the jump process (step ST9), the pointer 52 can be moved quickly as compared to the typical operation of sliding the finger over the operation surface 20a. It is therefore possible to quickly resize the window 50.

Furthermore, when the pad-type input device 20 is in the catch mode (step ST11), the pointer 52 instantly jumps to the resizing region 40a1, 40a2, 40a3, 40a4, 40b1, 40b2, 40c1, or 40c2 (step ST9), and the drag mode is automatically set in this stage (step ST11). Therefore, once a tap or touch is performed (step ST2), a drag operation is performed merely by sliding the finger in contact with the operation surface 20a again after moving the pointer 52 to the resizing region 40a1, 40a2, 40a3, 40a4, 40b1, 40b2, 40c1, or 40c2 (step ST9), thereby resizing the window 50. It is therefore possible to easily and quickly resize the window 50 without performing the drag mode switching operation to switch to the drag mode, such as the operation of double tapping the operation surface 20a or the operation of continuously pressing the left button 105.

What is claimed is:

1. An input device comprising:
an operation surface;
detecting means for detecting a contact of an operating object with the operation surface and determining coordinates of a position contacted by the operating object on the operation surface; and
data processing means for outputting a processing signal based on a detection signal obtained from the detecting means,
wherein, when a specific operation on a predetermined specific region on the operation surface is detected while displaying a resizable window on a display screen, the data processing means outputs a processing signal for allowing a pointer displayed on the display screen to jump to a resizing region of the window.

2. The input device according to claim 1, wherein the data processing means outputs a processing signal for catching the resizing region as well as allowing the pointer to jump to the resizing region when the specific operation on the predetermined specific region on the operation surface is detected.

3. The input device according to claim 1, wherein the specific operation is an operation of bringing the operating object into contact with the specific region.

4. The input device according to claim 1, wherein the data processing means determines whether or not the specific operation after the pointer jumps to the resizing region is detected, and outputs the processing signal for catching the resizing region after the predetermined operation is detected.

5. The input device according to claim 4, wherein the data processing means outputs the processing signal for catching the resizing region when an operation of the operation surface by the operating object is detected.

6. The input device according to claim 5, wherein the predetermined operation is a tap.

7. The input device according to claim 4, wherein a button input device is provided adjacent to the operation surface, and
the data processing means outputs the processing signal for catching the resizing region when an operation of the button input device is detected.

8. The input device according to claim 2, wherein when movement of the operating object over the operation surface is detected after the processing signal for catching the resizing region is output, the data processing means outputs a processing signal for changing the size of the window displayed on the display screen in accordance with the movement of the operating object.

9. The input device according to claim 2, wherein the data processing means outputs a processing signal for canceling a catch process of the resizing region when a release of the operating object from the operation surface is detected.

10. The input device according to claim 2, wherein the data processing means outputs a processing signal for canceling a catch process of the resizing region when a predetermined time elapses after the processing signal for catching the resizing region is output.

11. The input device according to claim 1, wherein setting means for setting the specific region on the operation surface is provided.

12. The input device according to claim 11, wherein the specific region is set so that the setting position on the operation surface and the size of the region can arbitrarily be set.
